(19) United States
(12) Patent Application Publication
(10) Pub. No.: US 2020/0294541 A1
(43) Pub. Date: Sep. 17, 2020

(54) MAGNETIC DISK DEVICE AND HEAD SEEK CONTROL METHOD

(71) Applicants: Kabushiki Kaisha Toshiba, Tokyo (JP); Toshiba Electronic Devices & Storage Corporation, Tokyo (JP)

(72) Inventor: Takeyori Hara, Kawasaki Kanagawa (JP)

(21) Appl. No.: 16/561,765

(22) Filed: Sep. 5, 2019

(30) Foreign Application Priority Data
Mar. 15, 2019 (JP) 2019-048723

(51) Int. Cl. G11B 5/55; G11B 21/08; G11B 19/28

(52) U.S. Cl. CPC G11B 5/556; G11B 19/28; G11B 21/083; G11B 5/5573

(57) ABSTRACT

According to one embodiment, a magnetic disk device includes a disk, a head that writes data to the disk and reads data from the disk, an actuator including a voice coil motor that moves the head over the disk, and a controller that increases a second current value applied to the voice coil motor during deceleration of the head in a seek according to a first current value that is maximum value capable of being applied to the voice coil motor during acceleration of the head in the seek on the disk.

### CROSS-REFERENCE TO RELATED APPLICATIONS

This application is based upon and claims the benefit of priority from Japanese Patent Application No. 2019-048723, filed Mar. 15, 2019, the entire contents of which are incorporated herein by reference.

### FIELD

Embodiments described herein relate generally to a magnetic disk device and a head seek control method.

### BACKGROUND

Magnetic disk devices change a current or a voltage applied to a voice coil motor (VCM) when a head is accelerated during head seek. Magnetic disk devices can apply a larger current to a VCM when a head is decelerated during head seek as compared to a case where a head is accelerated by a counter electromotive force or the like.

### BRIEF DESCRIPTION OF THE DRAWINGS

FIG. 1 is a schematic diagram illustrating an example of a configuration of a magnetic disk device according to an embodiment.

FIG. 2 is a plan view pictorially illustrating an example of a position of a head with respect to a disk.

FIG. 3 is a diagram illustrating an example of a target velocity curve according to an embodiment.

FIG. 4 is an enlarged view illustrating an example of a settling mode switching distance of the target velocity curve illustrated in FIG. 3.

FIG. 5 is a diagram illustrating an example of a change in head acceleration with respect to a remaining distance to the target radial position corresponding to the target velocity curve illustrated in FIG. 4.

FIG. 6 is a diagram illustrating an example of a current flowing to a VCM when a seek operation of a head according to an embodiment is performed.

FIG. 7 is a diagram illustrating an example of a head velocity when the seek operation illustrated in FIG. 6 is performed.

FIG. 8 is a diagram illustrating an example of a position of a head when the seek operation illustrated in FIG. 6 is performed.

FIG. 9 is a block diagram illustrating an example of a control system of head seek processing according to an embodiment.

FIG. 10 is a flowchart illustrating an example of each sample processing during acceleration according to an embodiment.

FIG. 11 is a flowchart illustrating an example of processing of updating a mode switching condition according to an embodiment.

### DETAILED DESCRIPTION

In general, according to one embodiment, a magnetic disk device comprises: a disk; a head that writes data to the disk and reads data from the disk; an actuator comprising a voice coil motor that moves the head over the disk; and a controller that increases a second current value applied to the voice coil motor during deceleration of the head in a seek according to a first current value that is maximum value capable of being applied to the voice coil motor during acceleration of the head in the seek on the disk.

Hereinafter, embodiments will be described with reference to the drawings. It should be noted that the drawings are merely examples and do not limit the scope of the invention.

### Embodiment

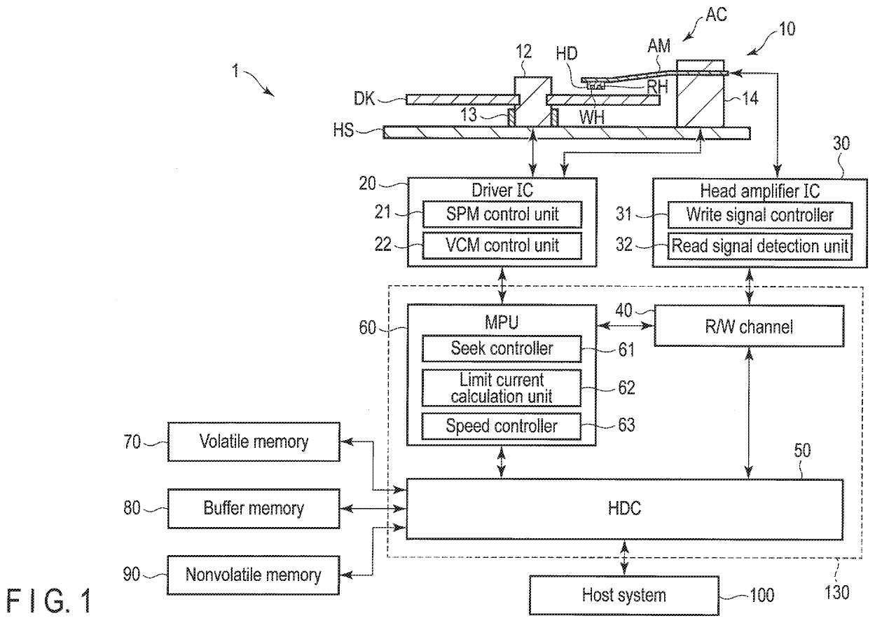

FIG. 1 is a schematic diagram illustrating an example of a configuration of a magnetic disk device 1 according to an embodiment.

The magnetic disk device 1 includes a housing HS, a head disk assembly (HDA) 10, a driver IC 20, a head amplifier integrated circuit (hereinafter referred to as a head amplifier IC or a preamplifier) 30, a volatile memory 70, a buffer memory (buffer) 80, a nonvolatile memory 90, and a system controller 130 that is a 1-chip integrated circuit. In addition, the magnetic disk device 1 is connected to a host system (hereinafter simply referred to as a host) 100. FIG. 1 pictorially illustrates a cross section of the HDA 10.

The HDA 10 includes a magnetic disk (hereinafter referred to as a disk) DK, a spindle motor (hereinafter referred to as SPM) 13 that rotates the disk DK around a spindle 12, an arm AM that carries a head HD, and a voice coil motor (hereinafter referred to as a VCM) 14. The SPM 13 and the VCM 14 are secured to the housing HS. The disk DK is attached to the spindle 12 and is rotated by the driving of the SPM 13. The head HD faces the disk DK. The arm AM and the VCM 14 constitute an actuator AC. The actuator AC rotates around the rotation axis to position the head HD attached to the tip of the arm AM at a particular position of the disk DK. Two or more disks DK and two or more heads HD may be provided. For example, at least two disks DK and at least two heads HD are provided.

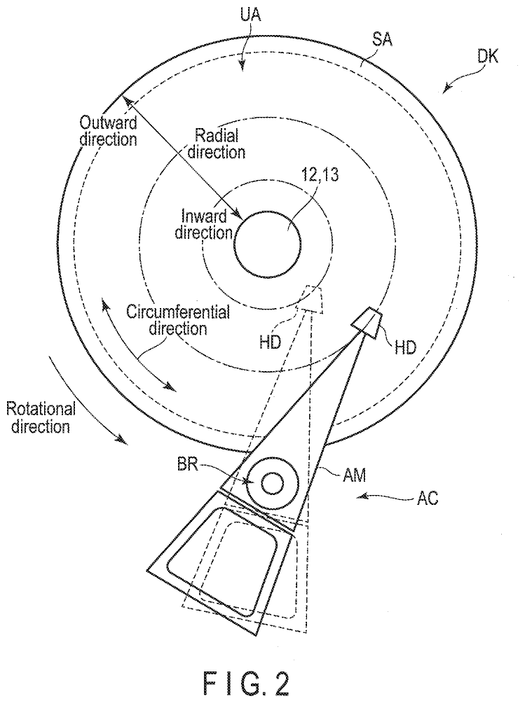

FIG. 2 is a plan view pictorially illustrating an example of the position of the head HD with respect to the disk DK. In the radial direction of the disk DK, the direction on the spindle 12 side is referred to as inward direction (inward), and the direction opposite to the inward direction is referred to as an outward direction (outward). The direction orthogonal to the radial direction of the disk DK is referred to as a circumferential direction. FIG. 2 illustrates the rotational direction of the disk DK in the circumferential direction. It should be noted that the rotational direction may be opposite to the direction illustrated in FIG. 2.

In the disk DK, a user data area UA available to a user, and a system area SA to which information necessary for system management (hereinafter also referred to as system information) is written are allocated to the area to which the data can be written. Hereinafter, a particular position of the disk DK in the radial direction may be referred to as a radial position, and a particular position of the disk DK in the circumferential direction may be referred to as a circumferential position. The radial position corresponds to, for example, a track, and the circumferential position corresponds to, for example, a sector. The radial position and the circumferential position may be collectively referred to simply as a position.

The head HD includes a slider as a main body, and includes a write head WH and a read head RH mounted on the slider so as to face the disk DK. The write head WH writes data to the disk DK. The read head RH reads data recorded on the track of the disk DK. As illustrated in FIG. 2, for example, the head HD slides in the horizontal plane of the disk DK during seek as the actuator AC rotationally drives around a bearing BR. Hereinafter, the position (for example, the radial position) of the head HD in the disk DK may be simply referred to as a head position.

The driver IC 20 drives the SPM 13 and the VCM 14 according to the control of the system controller 130 (specifically, the MPU 50 described later). The driver IC 20 includes an SPM control unit 21 and a VCM control unit 22. The SPM control unit 21 controls the rotation of the SPM 13. The VCM control unit 22 controls the VCM 14 by controlling the supplied current. It should be noted that part of the configuration of the driver IC 20 (for example, the SPM control unit 21 and the VCM control unit 22) may be included in the system controller 130.

The head amplifier IC (preamplifier) 30 amplifies a signal read from the disk DK and outputs the amplified signal to the system controller 130 (specifically, a read/write (R/W) channel 40 described later). In addition, the head amplifier IC 30 outputs, to the head HD, a write current corresponding to a signal output from the R/W channel 40. The head amplifier IC 30 includes a write signal controller 31 and a read signal detection unit 32. The write signal controller 31 controls a write current to be output to the head HD according to the control of the system controller 130 (specifically, the MPU 60 described later). The read signal detection unit 32 detects a signal written by the write head or a signal read by the read head. It should be noted that part of the configuration of the head amplifier IC 30 (for example, the write signal controller 31 and the read signal detection unit 32) may be included in the system controller 130.

The volatile memory 70 is a semiconductor memory in which stored data is lost when power supply is cut off. The volatile memory 70 stores data and the like necessary for processing in each unit of the magnetic disk device 1. The volatile memory 70 is, for example, a dynamic random access memory (DRAM) or a synchronous dynamic random access memory (SDRAM).

The buffer memory 80 is a semiconductor memory that temporarily records data and the like transmitted and received between the magnetic disk device 1 and the host 100. It should be noted that the buffer memory 80 may be integrated with the volatile memory 70. The buffer memory 80 is, for example, a DRAM, a static random access memory (SRAM), an SDRAM, a ferroelectric random access memory (FeRAM), and a magnetoresistive random access memory (MRAM).

The nonvolatile memory 90 is a semiconductor memory that records stored data even when power supply is cut off. The nonvolatile memory 90 is, for example, a NOR type or NAND type flash read only memory (FROM).

The system controller (controller) 130 is realized by, for example, using a large scale integrated circuit (LSI) called a system-on-a-chip (SoC) in which a plurality of elements are integrated on a single chip. The system controller 130 includes a read/write (R/W) channel 40, a hard disk controller (HDC) 50, and a microprocessor (MPU) 60. The system controller 130 is electrically connected to the driver IC 20, the head amplifier IC 30, the volatile memory 70, the buffer memory 80, the nonvolatile memory 90, and the host system 100. It should be noted that the system controller 130 may include the SPM control unit 21, the VCM control unit 22, the write signal controller 31, and the read signal detection unit 32. In addition, the system controller 130 may include the driver IC 20 and the head amplifier IC 30.

The R/W channel 40 performs signal processing of read data transferred from the disk DK to the host 100 and write data transferred from the host 100 in response to an instruction from the MPU 60 described later. The R/W channel 40 has a circuit or function that measures the signal quality of the read data. The R/W channel 40 is electrically connected to, for example, the head amplifier IC 30, the HDC 60, and the MPU 60.

The HDC 50 controls data transfer between the host 100 and the R/W channel 40 in response to an instruction from the MPU 60 described later. The HDC 50 is electrically connected to, for example, the R/W channel 40, the MPU 60, the volatile memory 70, the buffer memory 80, and the nonvolatile memory 90.

The MPU 60 is a main controller that controls each unit of the magnetic disk device 1 in response to an instruction from the host 100 or the like. The MPU 60 controls the actuator AC through the driver IC 20 and performs servo control for positioning the head HD. The MPU 60 controls the write operation of data to the disk DK and selects the storage destination of the write data. In addition, the MPU 60 controls the operation of reading data from the disk DK and controls the processing of read data. The MPU 60 is connected to each unit of the magnetic disk device 1. The MPU 60 is electrically connected to, for example, the driver IC 20, the R/W channel 40, and the HDC 50.

The MPU 60 includes a seek controller 61, a limit current calculation unit 62, and a velocity controller 63. The MPU 60 performs the processing of these units, such as the seek controller 61, the limit current calculation unit 62, and the velocity controller 63, on firmware. It should be noted that the MPU 60 may include these units as circuits. Part of the configuration of the MPU 60 may be included in the HDC 50. For example, the seek controller 61, the limit current calculation unit 62, and the velocity controller 63 may be provided in the HDC 50. In addition, the MPU 60 may include the configuration or function of the HDC 50.

The seek controller 61 controls the seek of the head HD from a particular radial position of the disk DK (hereafter also referred to as a start position) to a target radial position of the disk DK (hereafter referred to as a target position or a target radial position) in response to an instruction from the host 100 or the like. The seek controller 61 controls the velocity of the head HD (hereinafter also referred to as a head velocity) while seeking the head HD from the start position to the target position. During seek, the seek controller 61 controls the head velocity from the start position, completes the control of the head velocity near the target position, and switches the control of the head velocity to the settling of the head. For example, during seek, the seek controller 61 accelerates the head HD in a section in a particular radial direction (hereinafter also referred to as an acceleration section) or in a particular period (hereinafter also referred to as an acceleration period), moves the head HD at a constant velocity in a particular section (hereinafter also referred to as a constant velocity section) or in a period (hereinafter also referred to as a constant velocity period) subsequent to the acceleration section, decelerates the head HD in a particular section (hereinafter also referred to as a deceleration section) or in a period (hereinafter also referred to as a deceleration period) subsequent to the constant velocity section, and positions the head HD at the target position by settling in a particular section (hereinafter also referred to as a settling section) or in a period (hereinafter also referred to as a settling period) subsequent to the deceleration section. In other words, the seek controller 61 switches the control mode of the head velocity during seek. The seek controller 61 switches an acceleration mode for accelerating the head HD, a constant velocity mode for moving the head HD at a constant velocity, a deceleration mode for decelerating the head HD, and a settling mode for settling the head HD during seek. In addition, a state in which the acceleration mode is being performed may be referred to as an acceleration timing, a state in which the constant velocity mode is being performed may be referred to as a constant velocity timing, a state in which the deceleration mode is being performed may be referred to as a deceleration timing, and a state in which the settling mode is being performed may be referred to as a settling timing. It should be noted that, during seek, the seek controller 61 may accelerate the head HD in the acceleration section or the acceleration period, decelerate the head HD in the deceleration section subsequent to the acceleration section or the deceleration period subsequent to the acceleration period, and position the head HD at the target position by settling in the settling section subsequent to the deceleration section or the settling period subsequent to the deceleration period.

The limit current calculation unit (limit voltage calculation unit) 62 calculates a current value (voltage value) to be applied to the VCM 14. Hereinafter, the “current value or voltage value to be applied to the VCM 14” may be simply referred to as a “current value or voltage value”. The limit current calculation unit (limit voltage calculation unit) 62 detects a current value (hereinafter referred to as a saturation current value) or a voltage value (hereinafter referred to as a saturation voltage value) in a case of saturation acceleration on the head HD, and calculates (or estimates) a current value of the limit where a current or voltage does not saturate (hereinafter referred to as a limit current value) or a voltage value of the limit where a current or voltage does not saturate (hereinafter referred to as a limit voltage value) based on the saturation current value or the saturation voltage value. The limit current value (or the limit voltage value) is a value smaller than the saturation current value (or the saturation voltage value) and close to the saturation current value (the saturation voltage value). During acceleration, the limit current calculation unit 62 performs saturation acceleration on the head HD in a particular section (hereinafter also referred to as a saturation acceleration section) or in a particular period (hereinafter also referred to as a saturation acceleration period), detects (or estimates) a saturation current value, and calculates a limit current value based on the saturation current value. It should be noted that the limit current calculation unit 62 can estimate a resistance of the VCM 14 (hereinafter also referred to as a VCM resistance or a VCM resistance estimation value) based on the saturation current value and the head velocity when the saturation current value is applied to the VCM 14. The limit current calculation unit 62 can estimate a coil temperature of the VCM 14 (hereinafter also referred to simply as a coil temperature) based on the VCM resistance. In addition, the limit current calculation unit 62 may detect the current value or the voltage value.

The velocity controller 63 controls the head velocity through the VCM 14. In other words, the velocity controller 63 controls the head velocity by the current value (or the voltage value) applied to the VCM 14. It should be noted that the velocity controller 63 may control the head velocity by controlling the current value (or the voltage value) applied to the VCM 14 according to the VCM resistance or the coil temperature. The velocity controller 63 controls the head velocity according to a set velocity condition of the head HD, for example, a change in target head velocity with respect to the remaining distance to the target radial position (hereinafter referred to as a target velocity curve). Hereinafter, the “target head velocity” may be referred to as a “target velocity”. The velocity controller 63 controls the head velocity according to the target velocity curve (hereinafter also referred to as a nominal velocity curve) set based on a design nominal value, for example, a current value (hereinafter referred to as a nominal current value) or a voltage value (hereinafter referred to as a nominal voltage) set by design, an environmental temperature (hereinafter referred to as a nominal environmental temperature) set by design, and a coil temperature (hereinafter referred to as a nominal coil temperature) set by design, and the like.

The velocity controller 63 changes the velocity condition during deceleration, and controls the head velocity according to the changed velocity condition during deceleration. The velocity controller 63 increases the head velocity during deceleration or the current value (or the voltage value) during deceleration as compared to the head velocity during deceleration or the current value (or the voltage value) during deceleration, which is set by the design nominal value at the time of decelerating, for example, the nominal current value (or the nominal voltage value) during deceleration, the nominal environment temperature during deceleration, and the nominal coil temperature during deceleration, based on the limit current value (or the limit voltage value) calculated during acceleration. In other words, the velocity controller 63 increases the head velocity during deceleration or the current value (or the voltage value) during deceleration as compared to the head velocity during deceleration or the current value (or the voltage value) during deceleration, which is set by the design nominal value during decelerating, based on the saturation current value (or the saturation voltage value) detected during acceleration. The velocity controller 63 changes a target velocity curve (hereinafter referred to as a target deceleration curve), which is a reference during deceleration which is set based on the design nominal value during deceleration, to a target deceleration curve (hereinafter referred to as a limit deceleration curve) when the limit current value is applied to the VCM 14, based on the limit current value (or the limit voltage value). When changing from the target deceleration curve to the limit deceleration curve, the velocity controller 63 corrects the limit deceleration curve such that the state when switching from the deceleration mode to the settling mode in the limit deceleration curve matches the state before the change. For example, when changing from the target deceleration curve to the limit deceleration curve, the velocity controller 63 corrects the limit deceleration curve, such that the remaining distance to the target radial position (hereinafter referred to as the settling mode switching distance) for switching from the deceleration mode to the settling mode in the limit deceleration curve matches the settling mode switching distance in the target deceleration curve, and the acceleration of the head HD of the limit deceleration curve at the settling mode switching distance (hereinafter also referred to as head acceleration) matches the head acceleration of the target deceleration curve at the settling mode switching distance, and controls the head velocity according to the corrected limit deceleration curve. Hereinafter, the “head acceleration of the target deceleration curve at the settling mode switching distance” may be referred to as “settling mode switching acceleration”. The settling mode switching distance is a distance that corresponds to the distance of the boundary between the decelerating section and the settling section and corresponds to the end of the decelerating section or the decelerating period. It should be noted that the velocity controller 63 may change the target deceleration curve set based on the design nominal value during deceleration to the target deceleration curve (hereinafter also referred to as the saturation deceleration curve) when the saturation current value is applied to the VCM 14, based on the saturation current value, may correct the limit deceleration curve such that the settling mode switching state is matched as in the limit deceleration curve, and may control the head velocity according to the corrected saturation deceleration curve.

For example, the velocity controller 63 calculates the limit deceleration curve by multiplying the target deceleration curve by the coefficient x calculated based on a margin (hereinafter referred to simply as a current margin or a voltage margin) of the current value (or the voltage value) applied to the VCM 14 during acceleration, which is calculated according to the limit current value. For example, the velocity controller 63 calculates the coefficient x (=√(limit current value/nominal current value)) corresponding to the square root of the ratio of the limit current value to the nominal current value that is the reference from the current margin, and calculates the limit deceleration curve by multiplying the target deceleration curve by the coefficient x. The nominal current value is, for example, smaller than the limit current value. It should be noted that the velocity controller 63 may calculate the coefficient x (=√(limit voltage value/nominal voltage value during acceleration)) corresponding to the square root of the ratio of the limit voltage value to the nominal voltage value during acceleration from the voltage margin, and calculate the limit deceleration curve by multiplying the target deceleration curve by the coefficient x. The nominal voltage value is, for example, smaller than the limit voltage value. The target deceleration curve represents the change in the target velocity with respect to the remaining distance. Therefore, when this is multiplied by the coefficient x, the change in the remaining distance per time and the change in the target velocity per time are x times, respectively. The acceleration, that is, the change in velocity per time, is approximately x\hat{ }2 times. The velocity controller 63 detects a head velocity (hereinafter referred to as a corresponding velocity) and a head position (hereinafter referred to as a corresponding position) in the limit deceleration curve corresponding to the settling mode switching acceleration (the slope of the target deceleration curve at the settling mode switching distance), and calculates a target deceleration curve (hereinafter referred to as a corrected deceleration curve) in which the limit deceleration curve is corrected, based on a head velocity (hereinafter also referred to as a settling mode switching velocity) corresponding to the settling mode switching distance in the target deceleration curve and a difference value (hereinafter referred to as a velocity correction value) of the corresponding velocity, and a difference value (hereinafter referred to as a distance correction value) between the settling mode switching distance and the corresponding distance. The velocity controller 63 controls the head velocity according to the corrected deceleration curve during deceleration.

For example, the velocity controller 63 calculates the corrected deceleration curve by Equation (1) below.

Vref_cr=f(p+(p2−p1))×x+(v2−v1) (1)

Vref_cr is the corrected deceleration curve, x is the coefficient for calculating the limit deceleration curve by multiplying the target deceleration curve, f(p) is the target deceleration curve, p1 is the settling mode switching distance, p2 is the corresponding distance corresponding to the slope f′(p2)×x of the limit deceleration curve that is the same as the slope (settling mode switching acceleration) f′(p1) of the target deceleration curve at p1, that is, f′(p2)×x=f′(p1), v1 is the value of the target deceleration curve f(p1) when p=p1, that is, the settling mode switching velocity, and v2 is the value of the limit deceleration curve f(p2)×x when p=p2, that is, the corresponding velocity. In addition, f′(p) is a derivative of f(p). In other words, f′(p) corresponds to the first derivative of f(p).

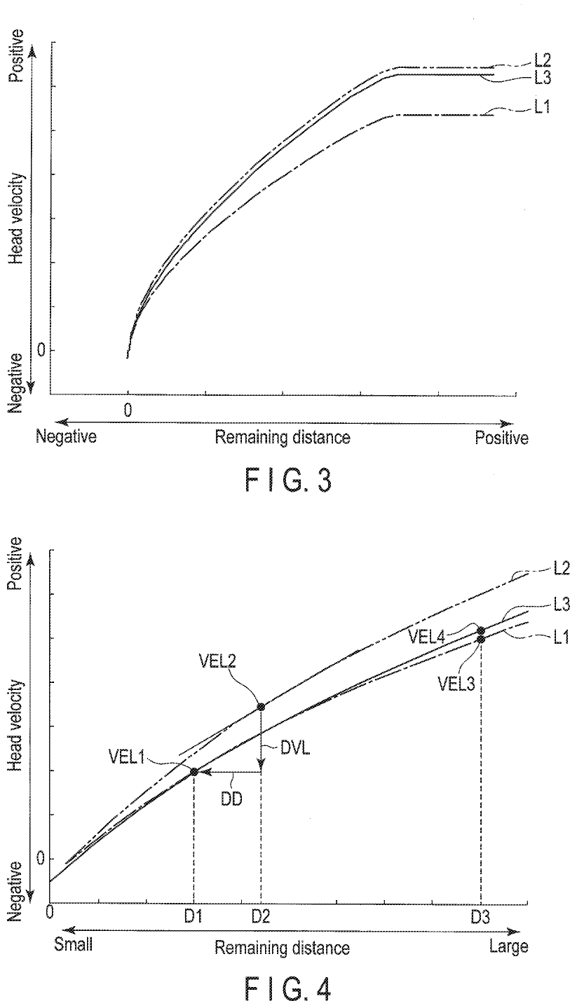

FIG. 3 is a diagram illustrating an example of the target velocity curve according to an embodiment. In FIG. 3, a horizontal axis indicates a remaining distance, and a vertical axis represents a head velocity. In the horizontal axis of FIG. 3, a value increases in the direction of the positive value as it proceeds in the direction of the positive arrow from the origin (=0), and a value decreases in the direction of the negative value as it proceeds in the direction of the negative arrow from the origin (=0). In the horizontal axis of FIG. 3, the origin (0) corresponds to the target position in the seek. In the vertical axis of FIG. 3, a value increases in the direction of the positive value as it proceeds in the direction of the positive arrow from the origin (=0), and a value decreases in the direction of the negative value as it proceeds in the direction of the negative arrow from the origin (=0). FIG. 3 illustrates a target deceleration curve L1, a limit deceleration curve L2, and a corrected deceleration curve L3.

In the example illustrated in FIG. 3, the velocity controller 63 calculates the limit deceleration curve L2 by multiplying the target deceleration curve L1 by the coefficient x, and corrects the limit deceleration curve L2 to the corrected deceleration curve L3. The velocity controller 63 controls the velocity of the head HD based on the remaining distance according to the corrected deceleration curve L3 during deceleration.

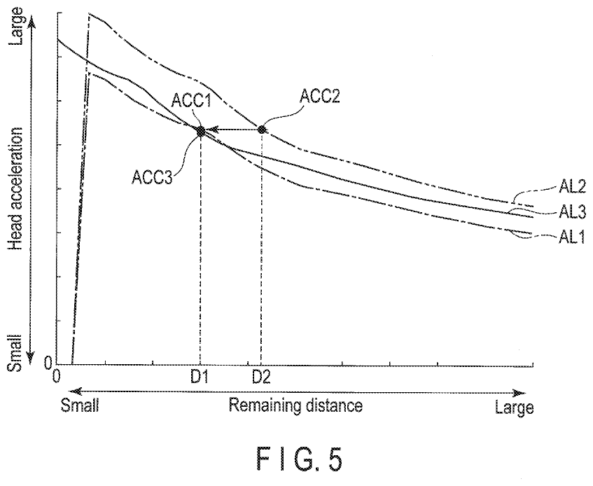

FIG. 4 is an enlarged view illustrating an example of the settling mode switching position D1 of the target velocity curve illustrated in FIG. 3, and FIG. 5 is a diagram illustrating an example of the change in head acceleration with respect to the remaining distance corresponding to the target velocity curve illustrated in FIG. 4. FIG. 5 illustrates changes AL1, AL2, and AL3 in head acceleration with respect to the remaining distance. The change AL1 in head acceleration illustrated in FIG. 5 corresponds to the target deceleration curve L1 illustrated in FIG. 4, the change AL2 in head acceleration illustrated in FIG. 5 corresponds to the limit deceleration curve L2 illustrated in FIG. 4, and the change AL3 in head acceleration illustrated in FIG. 5 corresponds to the corrected deceleration curve L3 illustrated in FIG. 4.

In FIGS. 4 and 5, a horizontal axis represents a remaining distance. In the horizontal axes of FIGS. 4 and 5, a value increases in the direction of the positive value as it proceeds in the direction of the positive arrow from the origin (=0), and it decreases in the direction of the negative value as it proceeds in the direction of the negative arrow from the origin (=0). In the horizontal axes of FIGS. 4 and 5, the origin (0) corresponds to the target position in the seek. In the horizontal axes of FIGS. 4 and 5, the remaining distance D1 corresponds to the settling mode switching position p1 described above, and the remaining distance D2 corresponds to a corresponding position corresponding to the slope (acceleration) of the limit deceleration curve that is the same as the slope (settling mode switching acceleration) of the target deceleration curve L1 at the settling mode switching position p1 described above. In addition, in the horizontal axis of FIG. 4, a remaining distance D3 is a particular remaining distance farther from the target position than the remaining distance D1 and D2.

In FIG. 4, a vertical axis represents a head velocity. In the vertical axis of FIG. 4, a value increases in the direction of the positive value as it proceeds in the direction of the positive arrow from the origin (=0), and a value decreases in the direction of the negative value as it proceeds in the direction of the negative arrow from the origin (=0). The vertical axis of FIG. 4 represents a head velocity (settling mode switching velocity) VEL1 of the target deceleration curve L1 corresponding to the remaining distance (settling mode switching position) D1, a head velocity (corresponding velocity) VEL2 of the limit deceleration curve L2 corresponding to the remaining distance (corresponding position) D2, a head velocity VEL3 of the target deceleration curve L1 corresponding to the remaining distance D3, and a head velocity VEL4 of the corrected deceleration curve L3 corresponding to the remaining distance D3.

In FIG. 5, a vertical axis represents a head acceleration. The value on the vertical axis of FIG. 5 corresponds to the first derivative of the value on the vertical axis of FIG. 4. In the vertical axis of FIG. 5, a value increases in the direction of the positive value as it proceeds in the direction of the positive arrow from the origin (=0), and a value decreases in the direction of the negative value as it proceeds in the direction of the negative arrow from the origin (=0). The vertical axis in FIG. 5 represents a head acceleration (settling mode switching acceleration) ACC1 of a change AL1 in head acceleration corresponding to the remaining distance (settling mode switching position) D1, a head acceleration ACC2 of a change AL2 in head acceleration corresponding to the remaining distance D2, and a head acceleration ACC3 of a change AL3 in head acceleration corresponding to the remaining distance D1. In FIG. 5, the head acceleration (settling mode switching acceleration) ACC1 and the head acceleration ACC3 match each other.

For example, the velocity controller 63 calculates the coefficient x corresponding to the square root of the ratio of the nominal current value during acceleration to the limit current value based on the current margin during acceleration calculated according to the limit current value, and calculates the limit deceleration curve L2 by multiplying the target deceleration curve L1 by the coefficient x as illustrated in FIG. 4. The velocity controller 63 detects the corresponding velocity VEL2 of the limit deceleration curve L2 corresponding to the head acceleration ACC2 and the corresponding position D2 corresponding to the head acceleration ACC2 in the change AL2 in head acceleration that is the same as the settling mode switching acceleration ACC1 of the settling mode switching position D1 in the target deceleration curve L1. The velocity controller 63 corrects the limit deceleration curve L2 to the corrected deceleration curve L3 based on the position correction value DD corresponding to the difference value between the settling mode switching position D1 and the corresponding position D2 and the velocity correction value DVL corresponding to the difference value between the settling mode switching velocity VEL1 and the head velocity VEL2. In other words, based on the position correction value DD and the velocity correction value DVL, the velocity controller 63 calculates the corrected deceleration curve L3 by moving the limit velocity curve L2 such that the corresponding velocity VEL2 at the corresponding position D2 of the limit velocity curve L2 matches the settling mode switching velocity VEL1 at the settling mode switching position D1 of the target deceleration curve L1. At this time, the head acceleration ACC3 of the change AL3 in the head acceleration corresponding to the settling mode switching position D1 matches the settling mode switching acceleration ACC1 corresponding to the settling mode switching position D1. For example, the corrected deceleration curve L3 is expressed as follows from Equation (1) described above.

L3=f(p+(D2−D1))×x+(VEL2−VEL1) (2)

The velocity controller 63 controls the head velocity according to the corrected deceleration curve L3 during deceleration.

In the example illustrated in FIG. 4, the head velocity VEL4 at the remaining distance D3 of the corrected deceleration curve L3 is larger than the head velocity VEL3 at the remaining distance D3 of the target deceleration curve L1. In addition, as described above, the corrected deceleration curve L3 and the target deceleration curve L1 match each other at the settling mode switching position D1. By controlling the head velocity according to the corrected deceleration curve L3 as illustrated in FIG. 4, it is possible to maximize the value of the current applied to the VCM 14, and it is possible to improve the head velocity during deceleration and stabilize the settling. For example, when the head velocity is controlled according to the target deceleration curve L1, the velocity controller 63 can apply, to the VCM 14, the current value up to about 70% of the nominal current value during deceleration, but when the head velocity is controlled according to the corrected deceleration curve L3, the velocity controller 63 can apply, to the VCM 14, the current value up to about 90% of the nominal current value during deceleration.

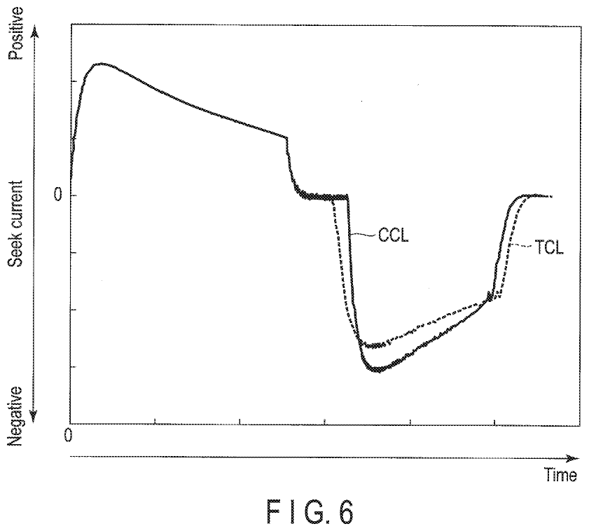

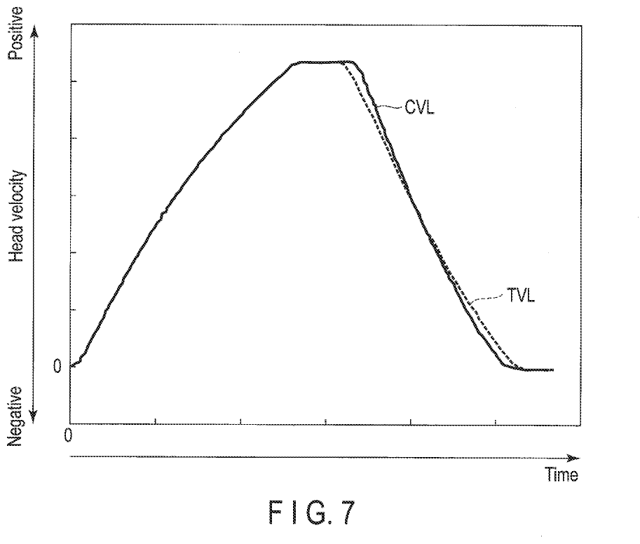

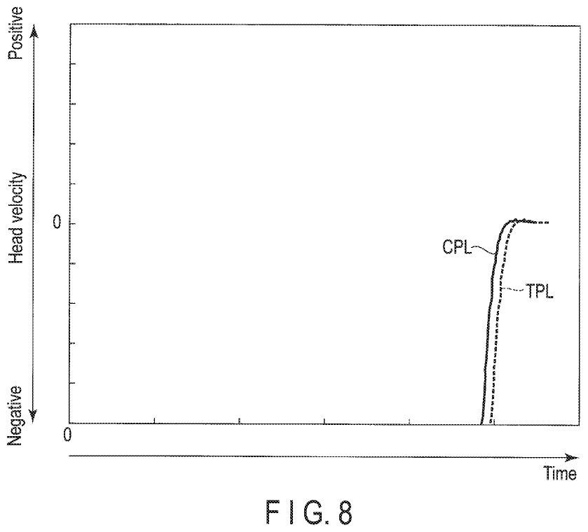

FIG. 6 is a diagram illustrating an example of the current flowing to the VCM when the seek operation according to the present embodiment is performed. FIG. 7 is a diagram illustrating an example of the head velocity when the seek operation according to the present embodiment is performed. FIG. 8 is a diagram illustrating an example of the head position when the seek operation according to the present embodiment is performed. In FIGS. 6 to 8, a horizontal axis represents a time. In the horizontal axes of FIGS. 6 to 8, the time progresses as it progresses in the direction of the tip of the arrow. In FIG. 6, a vertical axis represents the current applied to the VCM 14 during the seek of the head 15 (hereinafter also referred to as a seek current). In the vertical axis of FIG. 6, the seek current increases in the direction of the positive value as it proceeds in the direction of the positive arrow from the origin (=0), and the seek current decreases in the direction of the negative value as it proceeds in the direction of the negative arrow from the origin (=0). FIG. 6 illustrates the change CCL in seek current when deceleration control is performed based on the corrected deceleration curve, for example, the corrected deceleration curve L3 of FIGS. 3 and 4, and the change TCL in seek current when deceleration control is performed based on the target deceleration curve, for example, the target deceleration curve L1 of FIGS. 3 and 4. In FIG. 7, a vertical axis represents a head velocity between seeks of the head 15. In the vertical axis of FIG. 7, the head velocity increases in the direction of the positive value as it proceeds in the direction of the positive arrow from the origin (=0), and the head velocity decreases in the direction of the negative value as it proceeds in the direction of the negative arrow from the origin (=0). FIG. 7 illustrates the change CVL in head velocity when deceleration control is performed based on the corrected deceleration curve, for example, the corrected deceleration curve L3 of FIGS. 3 and 4, and the change TVL in head velocity when deceleration control is performed based on the target deceleration curve, for example, the target deceleration curve L1 of FIGS. 3 and 4. In FIG. 8, a vertical axis represents a head position between seeks of the head 15. In the vertical axis of FIG. 8, the head position increases in the direction of the positive value as it proceeds in the direction of the positive arrow from the origin (=0), and the head position decreases in the direction of the negative value as it proceeds in the direction of the negative arrow from the origin (=0). FIG. 8 illustrates the change CPL in head position when deceleration control is performed based on the corrected deceleration curve, for example, the corrected deceleration curve L3 of FIGS. 3 and 4, and the change TPL in head position when deceleration control is performed based on the target deceleration curve, for example, the target deceleration curve L1 of FIGS. 3 and 4. In the vertical axis of FIG. 8, the origin (=0) corresponds to the target position.

As illustrated in FIG. 6, the seek current during deceleration of the change CCL in the seek current is increased as compared to the seek current during deceleration which corresponds to the tip side of the arrow of the horizontal axis in the change TCL in seek current. In other words, when the deceleration control is performed based on the corrected deceleration curve, the seek current during deceleration is increased as compared to the case where the deceleration control is performed based on the target deceleration curve.

As illustrated in FIG. 7, when the deceleration control is performed based on the corrected deceleration curve, the change in head velocity during deceleration of the head velocity change CVL becomes steeper than the change in head velocity during deceleration of the head velocity change TVL, as compared to the case where the deceleration control is performed based on the target deceleration curve. In other words, when the deceleration control is performed based on the corrected deceleration curve, the change in head velocity becomes steeper as compared to the case where the deceleration control is performed based on the target deceleration curve.

As illustrated in FIG. 8, the head position during deceleration of the change CPL in head position reaches the target position more quickly than the seek current during deceleration of the change TPL in head position. In other words, the seek time is shortened by performing the deceleration control based on the corrected deceleration curve, as compared to the case where the deceleration control is performed based on the target deceleration curve.

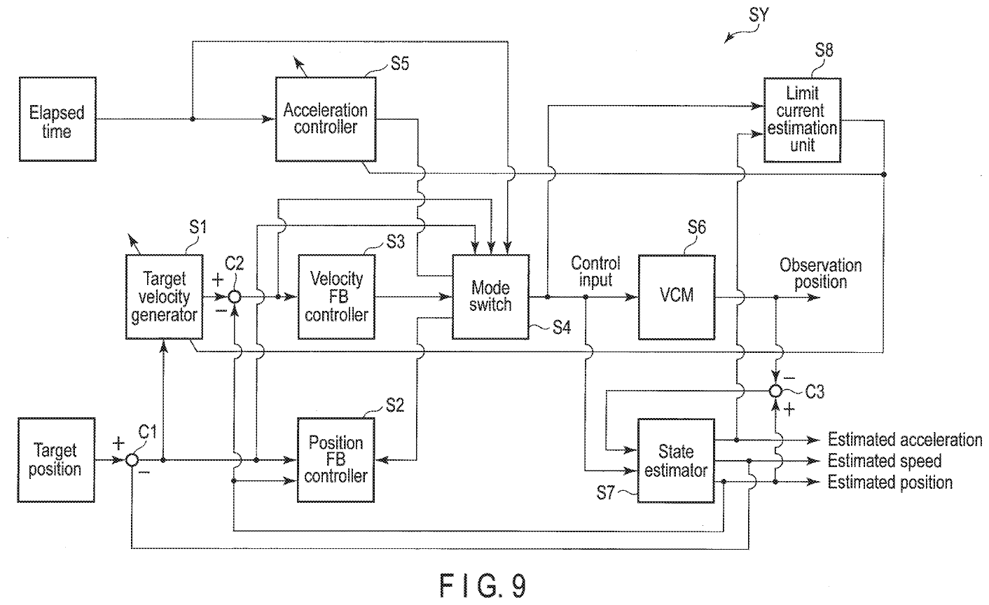

FIG. 9 is a block diagram illustrating an example of a control system SY of the seek processing of the head HD according to the present embodiment.

The magnetic disk device 1 includes a seek control system SY that performs seek processing of the head HD. The seek control system SY includes a target velocity generator S1, a position feedback (FB) controller S2, a velocity feedback (FB) controller S3, a mode switch S4, an acceleration controller S5, a VCM S6, a state estimator S7, a limit current estimation unit S8, and operating units C1, C2, and C3.

The target velocity generator S1 generates a target velocity of the head HD. The position feedback controller S2 performs feedback control associated with the position (for example, radial position) of the head HD. The velocity feedback controller S3 performs feedback control associated with the velocity of the head HD. The mode switch S4 switches the seek mode of the head HD, for example, an acceleration mode for accelerating the head HD, a constant velocity mode for moving the head HD at a constant velocity, a deceleration mode for decelerating the head HD, and a settling mode for performing settling, and the like. The acceleration controller S5 controls the acceleration of the head HD. The VCM S6 corresponds to the VCM 14 described above. The state estimator S7 is a state observer and has a plant model or an internal state variable. The state estimator S7 estimates the position (for example, radial position) of the next head HD. The limit current estimation unit S8 estimates (or calculates) the limit current value based on the saturation limit current and the like.

In the seek control system SY, the target position and the estimated velocity are input to the operating unit C1. The operating unit C1 inputs an output based on the target position and the estimated velocity to the target velocity generator S1, the position feedback controller S2, and the mode switch S4. The target velocity generator S1 inputs, to the operating unit C2, an output (target velocity) based on the target position, the estimated velocity, and the output (limit current value) from the limit current estimation unit. The operating unit C2 inputs an output from the target velocity generator S1 and an output based on the estimated position to the velocity feedback controller S3 and the mode switch S4. The position feedback controller S2 inputs an output based on the target position to the mode switch S4. The velocity feedback controller S3 inputs an output based on the output from the operating unit C2 to the mode switch S4. In addition, in the seek control system SY, an elapsed time from the start of the seek of the head HD (hereinafter simply referred to as elapsed time) is input to the mode switch S4 and the acceleration controller S5. The acceleration controller S5 inputs an output based on the elapsed time and the output from the limit current estimation unit S8 to the mode switch S4. Based on the target position, the elapsed time, the output from the target velocity generator S1, the output from the position feedback controller S2, the output from the velocity feedback controller S3, and the output from the acceleration controller S5, the mode switch S4 performs mode switching, for example, switching of the acceleration mode, the constant velocity mode, the deceleration mode, and the settling mode, and inputs a control signal for performing the switched mode to the VCM S6, the state estimator S7, and the limit current estimation unit S8. The VCM S6 is driven based on the control signal from the mode switch S4, moves the head HD to the observation position, and inputs an output (observation position) based on the driving amount to the operating unit C3. The operating unit C3 inputs an output based on the output (observation position) from the VCM S6 and the output (estimated position) from the state estimator S7 to the state estimator S7. The state estimator S7 calculates the estimated acceleration, the estimated velocity, and the estimated position based on the control signal from the mode switch S4 and the output from the operating unit C3, inputs the estimated position to the operating unit C2, the operating unit C3, and the position feedback controller S2, inputs the estimated velocity to the operating unit C1, and inputs the estimated acceleration to the limit current estimation unit S8. The limit current estimation unit S8 estimates the limit current value based on the control signal from the mode switch S4 and the estimated acceleration from the state estimator S7, and inputs the limit current value to the target velocity generator S1 and the acceleration controller S5.

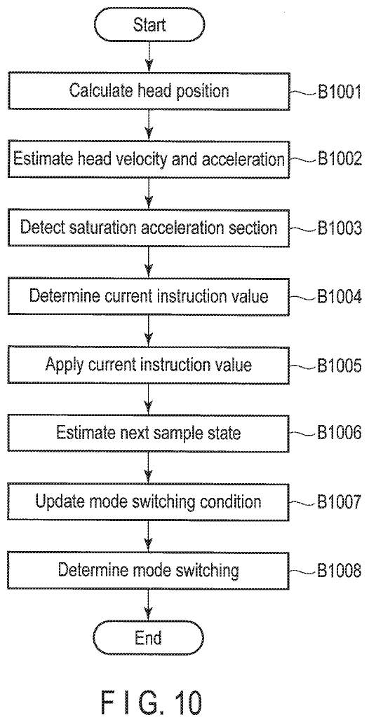

FIG. 10 is a flowchart illustrating an example of each sample processing during acceleration according to the present embodiment.

The MPU 60 calculates the head position (B1001), estimates the head velocity and the head acceleration (B1002), and detects the saturation acceleration section (B1003). The MPU 60 determines a current instruction value to be applied to the VCM 14 so as to perform saturation acceleration (B1004), and applies the determined current instruction value to the VCM 14 (B1005). The MPU 60 estimates the next sample state (B1006), updates the mode switching condition, for example, the settling mode switching condition (B1007), determines whether mode switching is to be performed (B1008), and ends the processing.

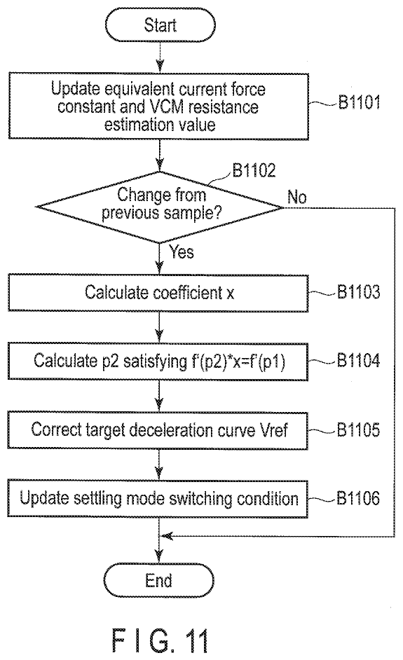

FIG. 11 is a flowchart illustrating an example of the processing of updating the mode switching condition according to the present embodiment. FIG. 11 corresponds to the processing of updating the mode switching condition of B1007 of FIG. 10.

The MPU 60 updates an equivalent current force constant and a VCM resistance estimation value (B1101), and determines whether an equivalent current force constant and a VCM resistance estimation value of a previous sample change (B1102). When it is determined that the change has not occurred (No in B1102), the MPU 60 ends the processing. When it is determined that the change has occurred (Yes in B1102), the MPU 60 calculates the coefficient x (B1103). The MPU 60 calculates the corresponding position p2 that satisfies f′(p2)×x=f′(p1) (B1104). The MPU 60, for example, calculates the limit deceleration curve by multiplying the target deceleration curve Vref by the coefficient x, and detects the settling mode switching position p1 and the settling mode switching velocity v1 corresponding to the settling mode switching position p1. The MPU 60 calculates the corresponding velocity v2=f(p2) based on the corresponding position p2. The MPU 60 corrects the target deceleration curve Vref to the corrected deceleration curve based on the coefficient x, the settling mode switching position p1, the settling mode switching velocity v1, the corresponding position p2, and the corresponding velocity v2 (B1105), updates the settling mode switching condition based on the corrected deceleration curve (B1106), and ends the processing.

According to the present embodiment, during acceleration, the magnetic disk device 1 performs saturation acceleration on the head HD, detects the saturation current value, and calculates the limit current value based on the saturation current value. The magnetic disk device 1 calculates the target deceleration curve based on the design nominal value during deceleration, and calculates the limit deceleration curve by multiplying the target deceleration curve by the coefficient x calculated based on the current margin during acceleration calculated according to the limit current value. When changing from the target deceleration curve to the limit deceleration curve, the magnetic disk device 1 detects the corresponding position and the corresponding velocity of the limit deceleration curve corresponding to the settling switching acceleration, and corrects the limit deceleration curve to the corrected deceleration curve based on the position correction value and the velocity correction value. When the head velocity is decelerated according to the corrected deceleration curve to perform settling during deceleration, the magnetic disk device 1 can increase the current value applied to the VCM 14 during deceleration, and can improve the head velocity during deceleration and stabilize settling. Therefore, the magnetic disk device 1 can shorten the seek time. Therefore, the magnetic disk device 1 can improve the access performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a disk;
a head that writes data to the disk and reads data from the disk;
an actuator comprising a voice coil motor that moves the head over the disk; and
a controller that increases a second current value applied to the voice coil motor during deceleration of the head in a seek according to a first current value that is maximum value capable of being applied to the voice coil motor during acceleration of the head in the seek on the disk.

2. The magnetic disk device according to claim 1, wherein the controller calculates the first current value by performing saturation acceleration on the head during the acceleration.

3. The magnetic disk device according to claim 1, wherein the controller changes a first change in a velocity of the head with respect to a remaining distance to a target radial position of the disk serving as a reference during the deceleration according to the first current value.

4. The magnetic disk device according to claim 3, wherein the controller calculates a second change in the velocity of the head with respect to the remaining distance to the target radial position during the deceleration larger than the first change based on the first current value during the acceleration, and calculates a third change in the velocity of the head with respect to the remaining distance to the target radial position during the deceleration having a second slope of the second change at a first distance that is the same as a first slope of the first change at the first distance to switch from the deceleration of the head to settling of the head, based on the second change.

5. The magnetic disk device according to claim 3, wherein the controller calculates a second change in the velocity of the head with respect to the remaining distance to the target radial position during the deceleration larger than the first change based on the first current value during the acceleration, detects a first velocity of the first change at a first distance to switch from the deceleration of the head to the settling of the head, a second distance of the second change corresponding to a second acceleration that is the same as a first acceleration corresponding to the first velocity, and a second velocity of the second change corresponding to the second acceleration, and corrects the second change based on a first difference value between the first distance and the second distance and a second difference value between the first velocity and the second velocity.

6. The magnetic disk device according to claim 4, wherein the controller calculates the second change by multiplying the first change by a square root of a first ratio of the first current value to a third current value applied to the voice coil motor that is smaller than the first current value during the acceleration.

7. The magnetic disk device according to claim 6, wherein the third current value is a current value applied to the voice coil motor as a reference during the acceleration.

8. The magnetic disk device according to claim 1, wherein the first current value is a maximum current value at which the head is not saturated during the acceleration.

9. A magnetic disk device comprising:
a disk;
a head that writes data to the disk and reads data from the disk;
an actuator including a voice coil motor that moves the head over the disk; and
a controller that controls the head based on a second change in velocity of the head with respect to a remaining distance to a target radial position during deceleration having a second slope at a first distance that is the same as a first slope of a first change in the velocity of the head at the remaining distance to a target radial position of the disk serving as a reference during the deceleration of the head at the first distance to switch from the deceleration of the head to acceleration of the head in a seek on the disk.

10. The magnetic disk device according to claim 9, wherein the second change is larger than the first change.

11. The magnetic disk device according to claim 10, wherein the controller controls the head based on the second change during the deceleration of the head in the seek.

12. A head seek control method applied to a magnetic disk device including a disk, a head that writes data to the disk and reads data from the disk, and an actuator including a voice coil motor that moves the head over the disk, the head seek control method comprising:
increasing a second current value applied to the voice coil motor during deceleration of the head in a seek according to a first current value that is a maximum value capable of being applied to the voice coil motor during acceleration of the head in the seek on the disk.

13. The head seek control method according to claim 12, further comprising:
calculating the first current value by performing saturation acceleration on the head during the acceleration.

14. The head seek control method according to claim 12, further comprising:
changing a first change in a velocity of the head with respect to a remaining distance to a target radial position of the disk serving as a reference during the deceleration according to the first current value.

15. The head seek control method according to claim 14, further comprising:
calculating a second change in the velocity of the head with respect to the remaining distance to the target radial position during the deceleration larger than the first change based on the first current value during the acceleration; and calculating a third change in the velocity of the head with respect to the remaining distance to the target radial position during the deceleration having a second slope of the second change at a first distance that is the same as a first slope of the first change at the first distance to switch from the deceleration of the head to settling of the head, based on the second change.

16. The head seek control method according to claim 14, further comprising:
calculating a second change in the velocity of the head with respect to the remaining distance to the target radial position during the deceleration larger than the first change based on the first current value during the acceleration;
detecting a first velocity of the first change at a first distance to switch from the deceleration of the head to the settling of the head, a second distance of the second change corresponding to a second acceleration that is the same as a first acceleration corresponding to the first velocity, and a second velocity of the second change corresponding to the second acceleration; and
correcting the second change based on a first difference value between the first distance and the second distance and a second difference value between the first velocity and the second velocity.

17. The head seek control method according to claim 15, further comprising:
calculating the second change by multiplying the first change by a square root of a first ratio of the first current value to a third current value applied to the voice coil motor that is smaller than the first current value during the acceleration.

18. The head seek control method according to claim 17, wherein the third current value is a current value applied to the voice coil motor as a reference during the acceleration.

19. The head seek control method according to claim 12, wherein the first current value is a maximum current value at which the head is not saturated during the acceleration.
